(19) United States
(12) Patent Application Publication
(10) Pub. No.: US 2002/0105749 A1
(43) Pub. Date: Aug. 8, 2002

(54) Communications device for non-contact semiconductor memories

(76) Inventors: Kazuyuki Hirooka, Kanagawa (JP); Yoshihisa Takayama, Kanagawa (JP)

Correspondence Address: COOPER & DUNHAM LLP, 1185 Avenue of the Americas, New York, NY, 10036, US

(21) Appl. No.: 10/020,463

(22) Filed: Oct. 30, 2001

(30) Foreign Application Priority Data
Nov. 6, 2000 (JP) P2000-342382
Mar. 22, 2001 (JP) P2001-083452

(51) Int. Cl. G11B 5/02; G11B 15/04; G11B 23/02

(52) U.S. Cl. 360/69; 360/132; 360/55; 360/60

(57) ABSTRACT

A low cost communications device (remote memory interface) highly adaptable to design changes. A data processing means encodes transmit data and decodes received data by software processing. A data processing means can be contrived for example with a general-purpose microcomputer, to decoded received data encode transmit data by software processing so that designing and mounting a dedicated IC is not necessary and a more compact communications device can be manufactured at a lower cost. The encode/decode method and other communications specifications can also be easily changed by modifying the software.

### BACKGROUND OF THE INVENTION

1. Field of the Invention

The present invention relates to a communications device such as for tape cassettes utilized in applications such as data storage and relates in particular to a communications device ideal for mounting in devices for recording media containing internal non-conductive type semiconductor memories.

2. Description of Related Art

Devices called tape streamer drives are known in the related art as drive devices capable of recording and playback of digital data on magnetic tape. Though also dependent on the tape length in the tape cassette constituting the medium, the tape has a huge recording capacity from several hundred to several thousand gigabytes. These tape streamer drives are therefore widely utilized in applications such as backing up the data recorded on media such as the hard disk of the computer. Tape streamer drives are also ideal for use in storing image data which has a huge data size.

Tape streamer drives as described above have been proposed as recording medium such as 8 millimeter VTR tape cassettes for recording and playback with rotary heads utilizing the helical scan method.

However, since the only medium in these kind of magnetic tape cassettes was the tape medium, data such as control data or system setting data (all types of data other than the main data for storage) was also recorded on the tape.

However, on many occasions during actual operation, the data on the tape cassette is preferably read while the tape cassette is in an unloaded state.

In devices for example such as library devices (changer devices) such as for storing a large number of tape cassettes in a magazine format and selectively supplying these tape cassettes to a tape streamer drive, the data is preferably read out by some means from the outer case of the cassette to identify a cassette that must be shipped, etc.

Methods were therefore conceived for identifying information (such as the number of the cassette) by affixing a barcode label for example to the cassette case and utilizing a library device to optically read out (scan) the barcode label to recognize the information.

The barcode method however was incapable of rewriting information and the information quantity was small so that the barcode method was inadequate for relatively sophisticated processing systems.

Tape cassettes incorporating nonvolatile memories within the cassette were developed for the above mentioned tape streamer systems.

These cassettes recorded information such as control information for data record/playback of the magnetic tape, and cassette usage history information and production information on the nonvolatile memory. Operation efficiency was greatly improved with this method compared to recording information such as control information on the magnetic tape.

More specifically, it was necessary to read and check information such as this control information each time it was recorded or played back on the magnetic tape and to rewrite it after recording or playback. When the control information for example was recorded at a designated position (for example, tape stop) on the magnetic tape, the tape had to be driven to this designated position before and after each record and playback operation. Furthermore, positions on the tape also had to be specified for performing operations such as tape loading and unloading. However if nonvolatile memories were used for recording information such as control information, then the above tasks were unnecessary.

Tape streamer drives were installed with connectors for accessing these nonvolatile memories.

In recent years, along with nonvolatile memories, antennas and communication devices installed inside the tape cassette, are being developed for achieving access in a non-contact state with the nonvolatile memory. In other words, by installing wireless communication type circuits in tape streamer drives, data can be recorded and played back on nonvolatile memories.

A tape cassette having a nonvolatile memory for this kind of non-contact wireless interface could be utilized for example reading out barcode data from the nonvolatile memory.

For example, when one wants to select a particular tape cassette from among many tape cassettes stored in the magazine of a library device, just reading out (scanning) the identification data on each cassette by wireless communication is sufficient to select that tape cassette.

The communications section comprising the interface for this type of non-contact memory however, incorporates an RF circuit (analog circuit) for transmitting and receiving data (modulation signals) by way of the antenna, and a digital circuit for encoding and decoding the transmitted and received data.

Custom (dedicated) IC circuits comprising this digital circuit for encoding and decoding the transmitted and received data were designed and installed.

However, the utilizing of this custom IC increases the development period and the costs and prevents manufacturing a compact and low-cost communications device. This custom IC must also be redesigned every time changes are made such as in the communications speed or the signal modulation (encoding/decoding) method also causing a longer device development period and higher development costs.

### SUMMARY OF THE INVENTION

In view of the above circumstances of the related art, the present invention is a communications (interface) device attached to a recording medium for sending and receiving data to a non-contact semiconductor memory having a memory section to store information relating to that recording medium, and a communications section for sending and receiving data to the storage section without making direct contact, in which the device comprises a sending/receiving means for sending and receiving by non-contact communication, and a data processing means for encoding transmit data and decoding receive data. The data processing means is comprised by a microcomputer, and along with encoding and decoding by software processing utilizing a memory section connected to or incorporated into this microcomputer, the clock frequency is a frequency matching the carrier frequency of the transmit/receive signal of this sending/receive means.

The above structure is further comprised of a clock generator means, and the clock and transmit/receive signal carrier of the data processing means are generated from the clock generator means based on the clock frequency.

The data processing means accumulates into the memory section the received data obtained from the sending/receiving means at specified periods, and decodes the received data that was accumulated in the memory section.

The data processing means encodes the transmit data in the memory section, and supplies a data stream of that transmit data to the sending/receiving means for transmission.

In other words, in the present invention, the data processing means encodes the transmit data and decodes the receive data by software processing. The data processing means is for example comprised by a general-purpose microcomputer and therefore is flexible versus changes in the design and specifications.

The clock frequency corresponds to the carrier of the transmit/receive signal so that synchronized processing is easy, and the device structure and software processing are simplified.

As can be seen by the foregoing description of the present invention, the data processing means encodes transmit data and decodes receive data by software processing. In other words, a data processing means comprised by a general-purpose microcomputer, encodes the transmit data and decodes the receive data by software processing so that a custom (dedicated) ID does not have to be designed and installed, thus rendering the effect that a lower-cost and more compact communications device can be achieved. Also, changes such as in the communications speed or the signal modulation (encoding/decoding) method can be handled by making software changes which also contributes to lowering the cost and shortening the communications device design time.

The clock frequency corresponds to the frequency of the transmit/receive signal carrier so that synchronized processing is easy, and the device structure and software processing are simplified.

The processing by the data processing means further utilizes the internal memory of the microcomputer or a connected memory as the memory section. The receive data for example is accumulated in the memory section, and the receive data accumulated in the memory section as data packets are decoded. Encoding is also performed on the data for transmission in the memory section that is configured as data packets, and a data stream of the applicable data packet is supplied to the sending/receiving means and transmitted. Checking of receive data and procedures for generating transmit data can be flexibly achieved by these kind of procedures.

### BRIEF DESCRIPTION OF THE DRAWINGS

FIG. 1 is a descriptive view showing the overall internal structure of the tape cassette utilized in the embodiment of the invention.

FIG. 2 is a perspective view showing an external view of the tape cassette of the embodiment.

FIG. 3 is a descriptive circuit diagram showing the communication method and the structure of the remote memory chip of the embodiment.

FIG. 4 is a descriptive view of the electromagnetic induction of the communication method of the embodiment.

FIGS. 5A and 5B are descriptive views (waveforms) showing the method for modulating the transmission data of the embodiment.

FIGS. 6A to 6D are descriptive views (waveforms) showing of the transmit/receive data of the embodiment.

FIG. 7 is a descriptive view of the transmit/receive data structure of the embodiment.

FIGS. 8A and 8B are descriptive views (diagrams) of the Manchester encoding of the embodiment.

FIG. 9 is a table showing the contents of the remote memory chip of the embodiment.

FIG. 10 is a block diagram of the tape streamer drive of the embodiment.

FIG. 11 is a descriptive view of the structure of the library device of the embodiment.

FIG. 12 is a descriptive view of the outer case structure of the library device of the embodiment.

FIG. 13 is a descriptive view of the magazine of the library device of the embodiment.

FIG. 14 is a descriptive view of the hand unit of the library device of the embodiment.

FIG. 15 is a descriptive view of the hand unit of the library device of the embodiment.

FIG. 16 is a descriptive view of the hand unit of the library device of the embodiment.

FIG. 17 is a block diagram of the library device of the embodiment.

FIG. 18 is a block diagram of the structure of the remote memory interface of the embodiment.

FIG. 19 is a flow chart of the transmit processing of the embodiment.

FIG. 20 is a flow chart of the receive processing of the embodiment.

### DETAILED DESCRIPTION OF THE PREFERRED EMBODIMENTS

The embodiments of the present invention are described next.

The example in this embodiment utilizes a data storage system comprised of a tape cassette installed with a nonvolatile memory, a tape drive device (tape streamer drive) capable of recording and playback of digital data for this tape cassette with memory, a library device capable of selectively storing many tape cassettes and loading them in the tape streamer drive, as well as a host computer, etc.

The tape streamer drive and library device read and write information by wireless data communication with the nonvolatile memory (remote memory chip) installed within the cassette. The example applicable to the present invention, is a communications device (remote memory interface) for wireless data communication with a remote memory chip installed in a library device.

The description is given in the following steps.

1. Tape cassette structure

2. Remote memory chip structure, communications method, and recorded data

3. Tape streamer drive structure

4. Library device structure

5. Remote memory interface structure and operation

1. Tape Cassette Structure

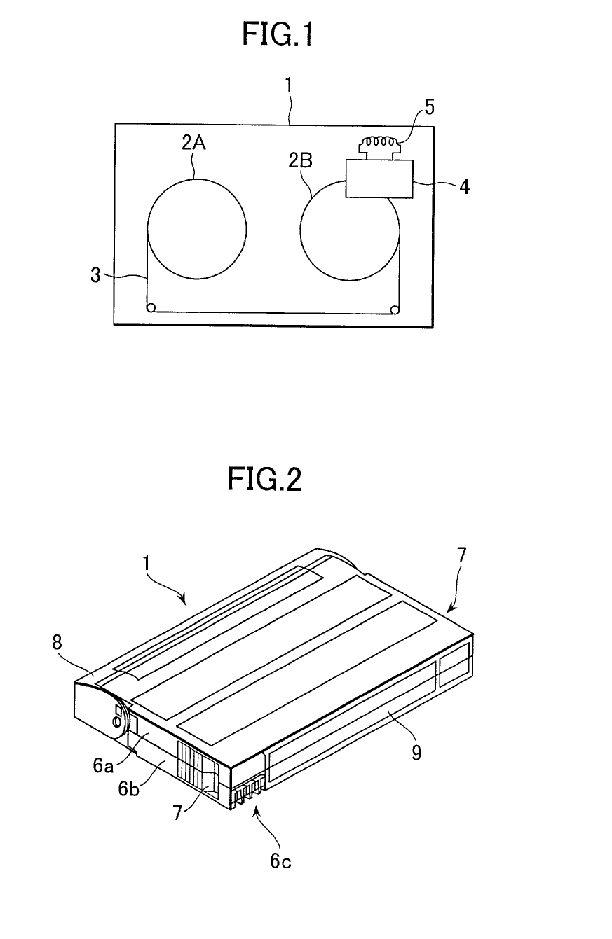

The tape cassette for the tape streamer drive and library device is described while referring to the FIG. 1 and FIG. 2.

FIG. 1 shows an overall view of the internal structure of a tape cassette 1. A reel 2a and 2b are installed inside the tape cassette 1 as shown in this figure. A magnetic tape 3 with a tape width of eight millimeters is wound between the reel 2a and the reel 2b.

A remote memory chip 4 incorporating a nonvolatile memory and a control circuit for the memory is installed in this tape cassette 1. This remote memory chip 4 is contrived to be able to perform data transfer by communication utilizing electromagnetic induction with the remote memory interfaces 30 and 32 with the tape streamer drive 10 and library device 50 described later on, and therefore is installed with an antenna 5.

Though described in detail later on, information such as production information and serial numbers, tape thickness and length, material, information relating to the usage history of data recorded for each partition and user information are stored on the remote memory chip 4.

In these specifications, information of various types stored on the remote memory chip 4 is mainly utilized for control of recording and playback of the magnetic tape 3 so this information is referred to collectively as “control information”.

By installing a nonvolatile memory within the tape cassette case and storing controlling information inside that nonvolatile memory in this way, and by providing an interface to read and write on that nonvolatile memory in the tape cassette of the tape streamer drive, the control information involving the recording and playback of data on magnetic tape can be read out and written on the nonvolatile memory, so that recording and playback on the magnetic tape 3 can be efficiently performed.

The magnetic tape for instance, does not have to be completely rewound when loading or unloading the tape, in other words, loading and unloading can be done from any position along the tape. The control information on the nonvolatile memory can be rewritten in data editing, etc. Furthermore, many partitions can be established on the tape to allow easy control when needed.

An external view of the tape cassette 1 is shown in FIG. 2. The overall case is comprised of a top case 6a, a lower case 6b and a guard panel 8. The structure is basically the same as the tape cassette used in an ordinary 8 millimeter VTR.

A terminal 6c is installed on the label surface 9 on the side of the tape cassette 1, and is an electrode terminal for a tape cassette having an internal contact type memory not described in this embodiment, and therefore not used in the type incorporating the non-contact remote memory chip 4 in this embodiment. It is provided here only to maintain the compatibility of the tape cassette shape in the device.

A cavity 7 is formed on both sides of the case to allow gripping the tape cassette when for example being conveyed by the library device 50 described later on.

2. Remote Memory Chip Structure, Communications Method, and Recorded Data

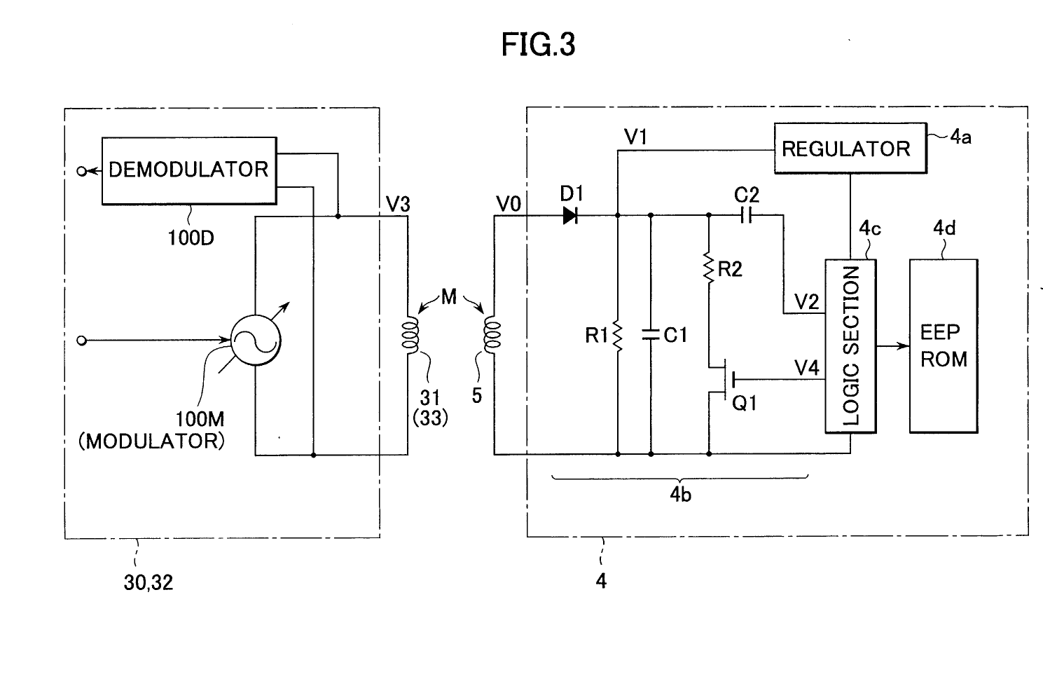

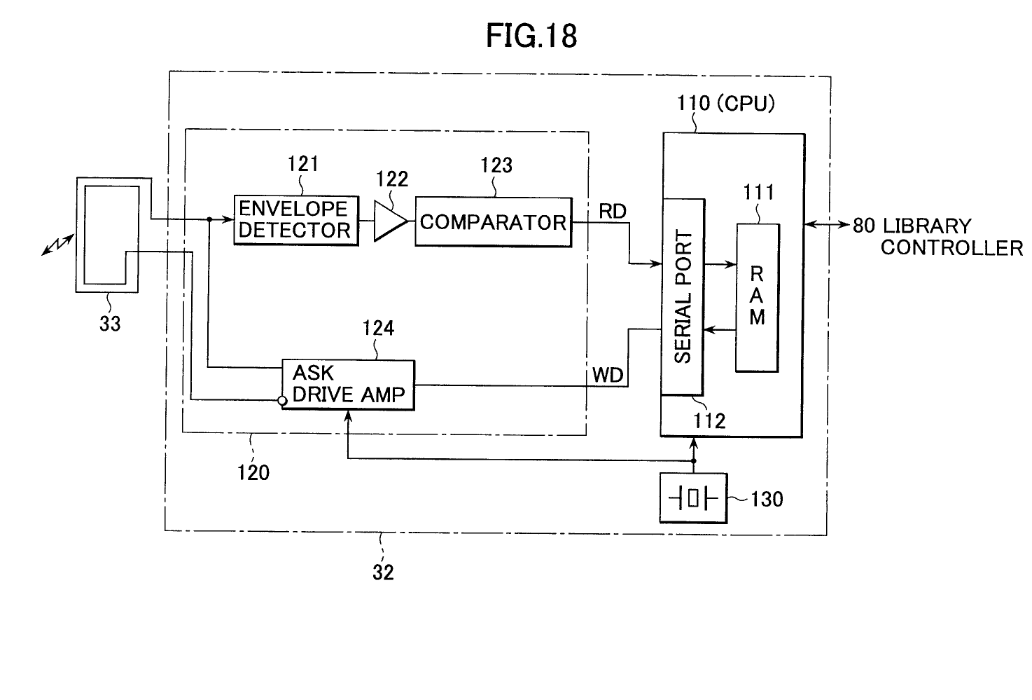

FIG. 3 shows the structure of the remote memory interface 30 (32) installed in the tape streamer drive and library device for communication between the remote memory chip 4 and the remote memory chip 4. A concept type block diagram is used in this figure to illustrate the communication method for the remote memory interface 30 (32). A detailed structure of the remote memory interface 32 of this embodiment is described later on in FIG. 18.

The remote memory chip 4 constituted by a semiconductor IC as shown in FIG. 3 contains a regulator 4a, RF section 4b, logic section 4c, and an EEP-ROM 4d. A remote memory chip 4 of this kind is mounted on a printed circuit board clamped inside a tape cassette 1, and an antenna 5 formed on the copper foil portion of the printed circuit board.

This remote memory chip 4 is configured to receive electrical power in a non-contact method supplied from an external section. A 13.56 MHz carrier wave for example is utilized for example for communications between the tape streamer drive 10 and the library device 50 related later on, and the regulator 4a converts this 13.56 MHz carrier wave to direct current power by receiving an electromagnetic field with the antenna 5 from the tape streamer drive 10 and the library device 50. This direct current power is supplied as the operating power source for the RF section 4b and the logic section 4c.

In the RF section 4b, a diode D1, resistors R1, R2, condensers C1, C2 and switching element Q1 are connected for example, as shown in the figure, and along with supplying the received information (inductive voltage) to the logic section 4c, a switching control voltage V4 from the logic section 4c modulates the information for transmitting.

The logic section 4c controls processes such as the read and write processing on for example the EEP-ROM 4d according to the decoded information (commands) and decoded receive signals from the RF section 4b.

The remote memory interfaces 30 and 32 on the other hand, modulate the 13.56 MHz carrier wave by means of transmit data in a modulator 100M, and transmit it (the modulated carrier) from the antenna 31 to the remote memory chip 4. The information sent from the remote memory chip 4 is demodulated by a demodulator 100D and the data obtained.

Communication between the remote memory chip 4 and the remote memory interfaces 30 and 32 is described next.

The communication between the remote memory chip 4 and the remote memory interfaces 30 and 32 is basically performed based on the principle of electromagnetic induction.

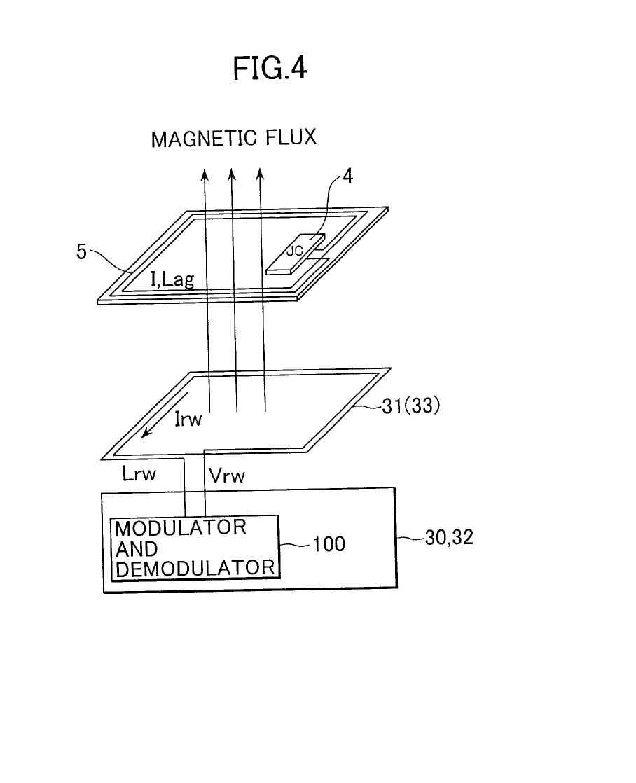

An antenna 31 (33) connected to the remote memory interfaces 30, 32 as shown in FIG. 4, is formed as a loop coil Lrw. A magnetic field is generated on the periphery of the loop coil Lrw by making an electrical current Irw flow in this antenna 31 (33).

An antenna 5 on the other hand connected to the remote memory chip 4 is formed by a loop coil Ltag, and an electromagnetic voltage from a magnetic filed emitted from the loop coil Lrw, is generated in the end of the loop coil Ltag, and this is input to the IC constituting the remote memory chip 4.

The extent of coupling of the antenna 31 and the antenna 5 changes according to their positional relationship, so an M-coupled transformer is provided, and a model is therefore shown as in FIG. 3.

Though not shown in FIG. 3, a resonant condenser may be connected to the antennas 5, 31 to extend the communication distance. When the communication distance is long and the magnetic field coupling the loop coil Lrw and loop coil Ltag becomes small, adding this condenser can increase the resonance. In other words, the voltage generated in the loop coil Ltag increases due to resonance, so that the communication distance which is limited by the power required by the remote memory chip 4 can be extended. The impedance of the resonant circuit increases so that during transmission the amplitude modulation fluctuations of the loop coil Lrw are transmitted more efficiently than the loop coil Ltag. During receive, the impedance fluctuations (described later on) of the remote memory chip 4 are transmitted more efficiently.

The magnetic field emitted by the antennas 31 (33) and the inductive voltage of the remote memory chip 4 are varied according to the electrical current flowing in the antennas 31 (33). The modulator 100M in the remote memory interfaces 30, 32 therefore modulates the current of the antennas 31 (33), so that data can be transmitted to the remote memory chip 4. The remote memory interfaces 30, 32 in other words modulate the magnetic field with transmit data, and the remote memory chip 4 demodulates the components by using the diode D1 and condenser C2 of the inductive voltage that was input, or in other words demodulate the data from the alternating current component V2 appearing after rectification.

When sending data back to the remote memory interfaces 30 and 32 the remote memory chip 4 varies the input impedance according that transmit data. An oscillator is therefore not installed for sending data to the remote memory chip 4.

The logic section 4c in other words, supplies the transmit data V4 to the gate of the switching element Q1 to drive the switching element Q1. The effect of the resistor R2 on the input impedance is turned on and off in this way, and the input impedance varies.

When the impedance as seen from the antenna 5 of remote memory chip 4 changes, the impedance of the M-coupled antennas 31 (32) also changes, and a fluctuation in this way appears in the electrical current Irw and voltage Vrw across the terminals of the antenna 31 (33). The variable (fluctuating) component is demodulated in the demodulator 100D of the remote memory interfaces 30, 32, and data can be received from the remote memory chip 4.

The remote memory chip 4 itself possesses no battery, and after detecting the induction voltage caused in the antenna 5, the regulator 4a as described above, obtains a current and voltage from the direct current components of the voltage V1.

The induction voltage V0 is affected by the variations (fluctuations) occurring due to the functioning of the remote memory chip 4 and also due the transmit/receive data, so that the voltage must be stabilized with the regulator 4a in order to achieve stable operation of the remote memory chip 4.

Therefore, when the remote memory interfaces 30, 32 are communicating with the remote memory chip 4, the remote memory chip 4 is set to power-on by first outputting a carrier wave from the antennas 31 (33). That power-on condition is then maintained until completion of a series of communication access (write and read) During transmit of command for read and write, the remote memory interfaces 30, 32 perform ASK (amplitude shift keying) modulation and send command data to the remote memory chip 4. When the remote memory interfaces 30, 32 receive an acknowledgment from the remote memory chip 4 for these transmit commands, ASK demodulation of the carrier wave is performed and the receive data obtained.

In the period of repeated access with the remote memory chip 4, the remote memory interfaces 30, 32 continue to output a carrier wave, so the remote memory chip 4 is maintained at power-on.

The data clock required for communication in the remote memory chip 4 is obtained by frequency division of the 13.56 MHz carrier frequency of the remote memory interface 30, 32 and generating it in the logic section 4.

The signal sent to the remote memory chip 4 from the remote memory interfaces 30, 32 is ASK modulated by transmit data on the 13.56 MHz carrier frequency.

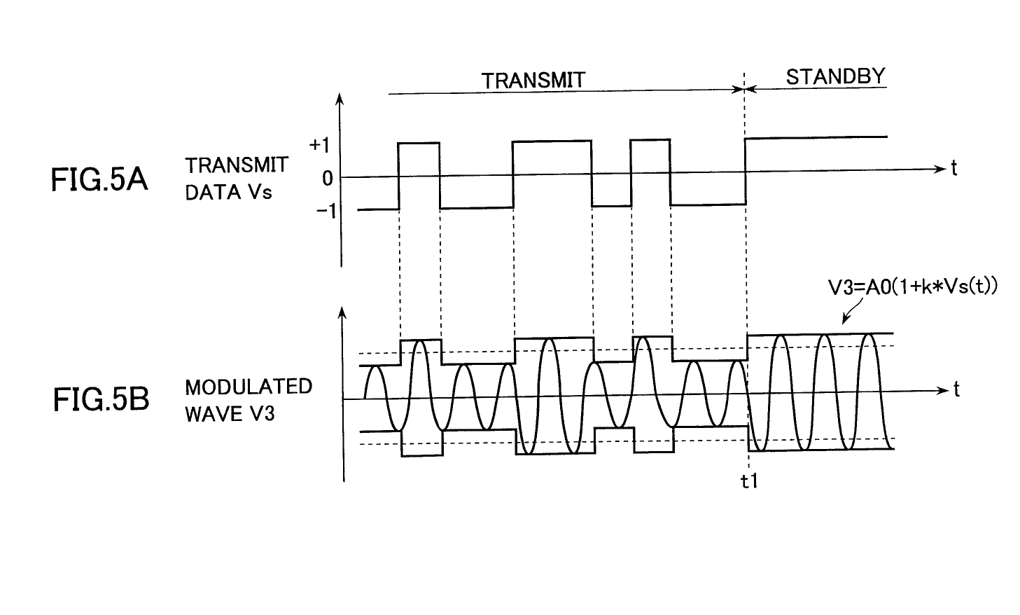

The ASK demodulation signal is shown in FIG. 5A and FIG. 5B. Transmit data Vs such as in FIG. 5A, modulates the carrier A0, and an ASK modulation signal V3 as shown in FIG. 5B is obtained. This ASK modulated wave V3 is expressed by V3=A0(1+k*Vs (t)).

The ASK modulation rate is for example 15 percent.

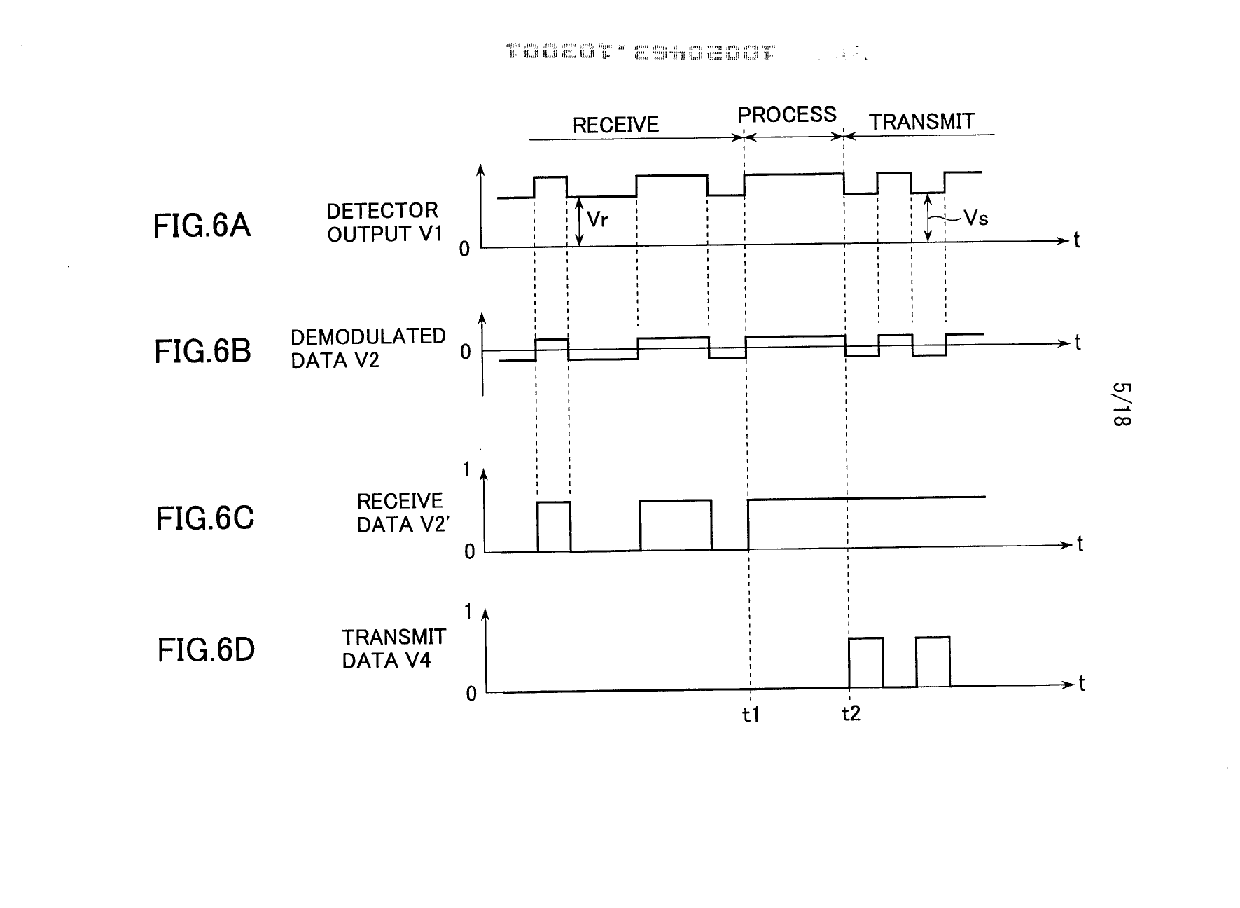

The remote memory chip 4 send and receive signals are shown in FIG. 6A through FIG. 6D.

This ASK (amplitude shift keying) modulated wave V3 generated in the remote memory interfaces 30, 32, appears as an inductive voltage V0 in the antenna 5 of remote memory chip 4. The carrier wave that was envelope-detected by the detector circuit (diode D1), is obtained as a detector output V1 as in FIG. 6A. Besides transmit data from the remote memory interfaces 30, 32, this detector output V1 also contains data transmitted by the remote memory chip 4 itself.

The DC component is then eliminated by the condenser C2, and the demodulated data V2 such as in FIG. 6B is input to the logic section 4c.

The logic sum of the demodulated data V2 and receive window t1 are obtained in the logic section 4c, and the actual receive data V2′ is restored as shown in FIG. 6C. The transmit data is in this way obtained on the remote memory chip 4 side from the remote memory interfaces 30, 32.

The remote memory chip 4 that received the data, sends the required data to the remote memory interfaces 30, 32 after processing of the data from periods t1 through t2. Transmit data V4 for example is shown in FIG. 6D, and the switching element Q1 is turned on and off by this transmit data V4 so that the impedance is varied as described above, and the data is in this way sent to the remote memory interfaces 30, 32.

The impedance (fluctuation) variation rate in this case is for example 50 percent or more.

On the remote interface 30, 32 side, the impedance variation at the remote memory chip 4 causes variations (fluctuations) in the electrical current Irw and voltage Vrw in the antennas 31 (33) coupled by M-coupling so that upon detection of this variation (fluctuation), the transmitted data is demodulated by the demodulator 100D.

The modulated wave V3 is expressed as V3=A0*(1+m*V4 (t)) at this time. The extent of M-coupling is greatly dependent on the distance between remote memory chip 4 and the remote memory interface 30, 32 so that obtaining a large impedance on the remote memory chip 4 side is important.

A detector output is obtained in the same way as FIG. 6A even on the remote memory interface 30, 32 side, and by binarizing the signal of FIG. 6B, receive data such as in FIG. 6C is obtained.

The above described the sending and receiving of data between the remote memory interface 30, 32 and the remote memory chip 4.

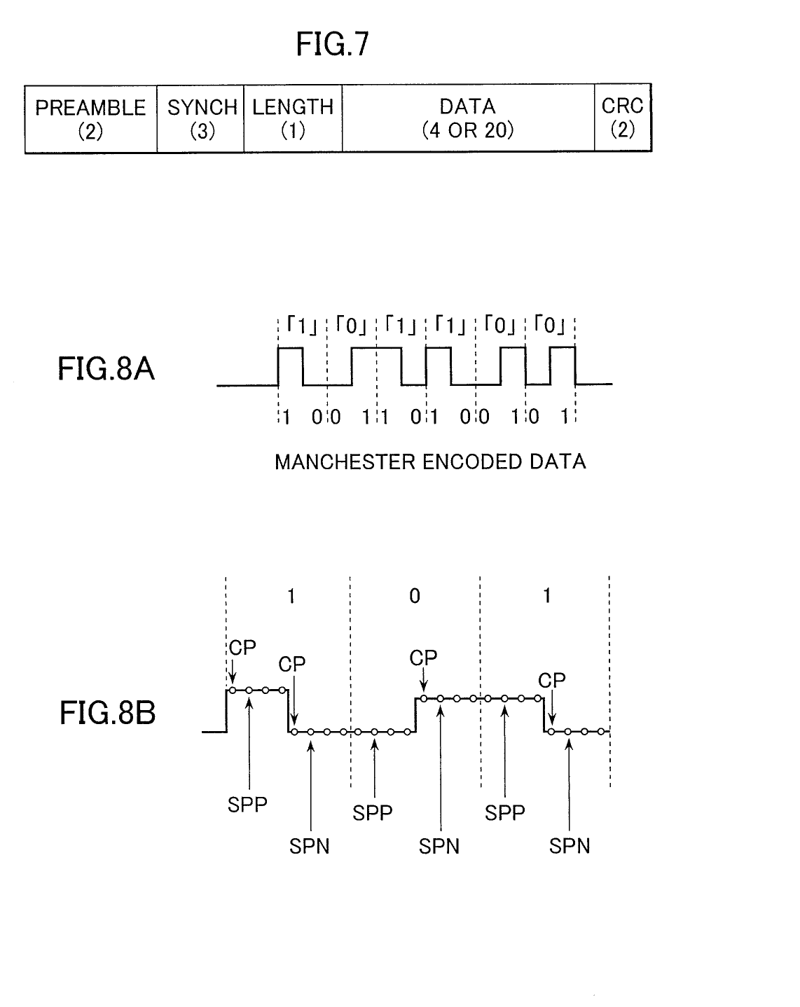

The sent and received data has a structure as shown in FIG. 7. In other words, a 2-byte preamble, a 3-byte synch, a 1-byte length, 4 or 20 bytes of data, and a 2-byte CRC (cyclic redundancy check).

The preamble is added with the objective of synchronizing the transmitted data with a clock pulse. A synch is then added after preamble, as a start position check and a logic check. The length is then added to indicate the data length. Following the data, a CRC is added having error detection and error correction capability.

The data for sending and receiving between the remote memory interfaces 30, 32 and the remote memory chip 4 is data subjected to so-called Manchester encoding.

Manchester encoding is a type of BPSK (binarypulse shift keying) modulation and data of “0” is sent as “01”; and data of “1” is sent as “10”. The DC components are therefore treated so as not to ride the signal.

The coding clock pulse divides the 13.56 MHz carrier wave by 64 for use at approximately 212 KHz. The bit rate of the transmit/receive data is therefore equivalent to 106 Kbps.

An example of Manchester encoding is shown in FIG. 8A.

Here, if the data string for transmitting is “101100”, then “01” or “10” is encoded with the binary clock, so the data becomes, “100110100101”. Even if the data has successive “0”s or “1”s, the ASK (amplitude shift keying) modulates the carrier with a “01”or “10” so that the DC component does not ride the signal.

During modulation of the carrier wave, a “01” is a “large/small” amplitude, and a “10” is a “small/large” amplitude.

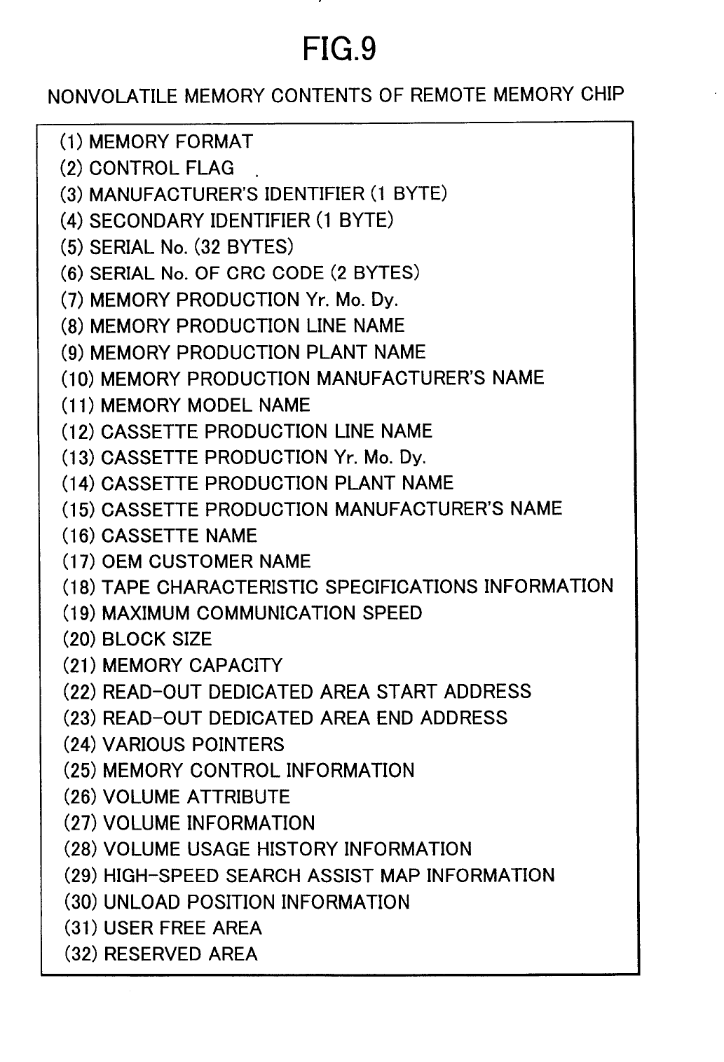

FIG. 9 next shows an example of control information contents stored on the EEP-ROM 4d of remote memory chip 4. The numerals (1) through (32) in the figure are used only for the purpose of convenience in the description and do not correspond to the data position format within this EEP-ROM 4d. The contents shown in this list are an example, and in some cases, contents not shown in the example may also be stored.

Each item in the contents is briefly explained.

(1) Memory Format

This content item shows the type of format for the memory installed within the tape cassette 1 such as a contact type or non-contact type format. In this example, a numeral showing the non-contact type is stored in the remote memory chip 4.

(2) Control Flag

This content item lists the type of status during shipment from the factory.

(3) Manufacturer's Identifier (1 byte)

This content item lists the code number of the manufacture of this cassette tape 1. A one byte code value is set for example according to the manufacturer and stored.

(4) Secondary Identifier

This content item lists the attribute information of the tape or in other words, is the type information for the tape cassette 1. A one byte code value is set respectively according to the type of tape cassette 1, and the applicable code value is stored.

(5) Serial No. (32 Bytes)

This content item lists the particular number comprised of 32 characters (32 bytes) stored in the remote memory chip. A unique (or characteristic) code is respectively assigned to each tape cassette 1.

(6) Serial No. of CRC Code (2 Bytes)

This content item lists the two-byte CRC for the above mentioned 32 byte serial number.

The total 36 bytes of information constituting the manufacturer's identifier, secondary identifier, serial number and CRC code for the serial number in the content items (3) through (6), are particular information for each tape cassette as data listed during shipment. This information is utilized for example in certifying the cassette.

(7) Memory Production Yr. Mo. Dy.

(8) Memory Production Line Name

(9) Memory Production Plant Name

(10) Memory Production Manufacturer's Name

(11) Memory Model Name

(12) Cassette Production Line Name

(13) Cassette Production Yr. Mo. Dy.

(14) Cassette Production Plant Name

(15) Cassette Production Manufacturer's Name

(16) Cassette Name

Data equivalent to each of the above respective content items is listed.

(17) OEM Customer Name

This content item lists the OEM customer name but when destined for general use is listed as “GENERIC”.

(18) Tape Characteristic Specifications Information

This content item lists information such as magnetic characteristics, electrical characteristics, length and tape thickness of the magnetic tape 3.

(19) Maximum Communication Speed

This content item lists the information transfer rate of the memory.

(20) Block Size

This content item lists the memory block size such as “16 bytes”.

(21) Memory Capacity

This content item lists the memory capacity such as “8KByte”.

(22) Read-out Dedicated Area Start Address

For example, 0000h.

(23) Read-out Dedicated Area End Address

For example, 00FFh.

(24) Various Pointers

The pointer to each data type on the memory, forming the route for the list structure data type.

(25) Memory Control Information

Content item listing control information relating to the memory.

(26) Volume Attribute

Content item listing information such as the read-prohibit, write-prohibit on the magnetic tape 3 during intermittent processing.

(27) Volume Information

Content item listing information relating to the volume history such as the initialization count and number of partitions on the magnetic tape 3.

(28) Volume Usage History Information

Content item listing information for overall usage of the cassette by calculating the usage history of each partition on the magnetic tape 3. This includes not only the loading count for the tape, but also characteristic information involving the volume such as the loading count for the cassette.

(29) High-speed Search Assist Map Information

Content item listing data map information necessary for implementing a high speed search function to make maximum use of reel motor performance without obtaining ID information in real-time from the magnetic tape 3.

The operation of this high speed search function is as follows. In a process for recording data on the magnetic tape 3, the logic position information is written on a high-speed search support map at each 10 meters of tape drive. When then searching for the file position on the magnetic tape 3, this map is first checked, and the nearest position further having a sufficient tape margin before the next 10 meter position is selected. The tape thickness and reel diameter is already known so that by calculating the reel FG pulses up to the calculated position, the tape can be fed without having to read the tape ID at all. In other words, the tape can be driven at high speed without having to read out the ID from the magnetic tape. Upon reaching the calculated position during this kind of high-speed tape drive, the tape then slows to a speed where the ID data can be read out from the magnetic tape 3, and a normal high-speed search is made for the final file position specified by the host computer.

(30) Unload Position Information

Multiple partitions appended with numbers in order, from the beginning of the magnetic tape can be efficiently monitored by using the memory (remote memory map).

Multiple partition specifications allow loading and unloading at each partition (unit) however to unload at a particular partition, a check must be made to find whether the tape was loaded again at the previous unloading position.

So in such cases, the unloading position must be stored in the memory. This assures that even if mistakenly loaded at another location that the mistake will be detected, and prevents unexpected writing on an unscheduled position or readout at an unscheduled position.

(31) User Free Area

The user free area is a memory area freely writable by the user via a serial Interface and a host interface (SCSI) over the Internet. The serial interface is contained in the drive device, and is utilizable by the library controller and for maintenance.

(32) Reserved Area

An empty area of the memory available for use during future expansion.

3. Tape Streamer Drive Structure

The tape streamer system of this embodiment is comprised of a tape streamer drive 10 for recording and playback of a magnetic tape 3 of the tape cassette 1, a library device 50 capable of storing many tape cassettes 1 and selectively loading them in the tape streamer drive 10, and also a host computer for controlling the (device) operation. The library device 50 and the tape streamer drive 10 are capable of communicating with the remote memory chip 4 of tape cassette 1.

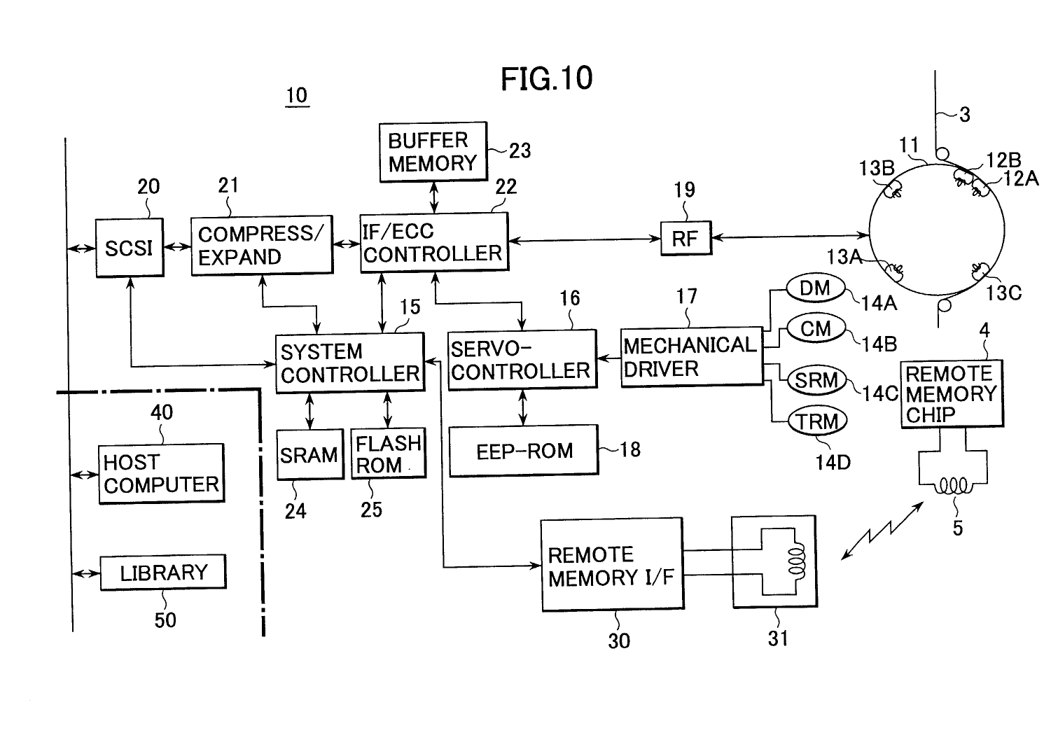

The structure of the tape streamer drive 10 is first explained here while referring to FIG. 10. This tape streamer drive 10 records and plays back the magnetic tape 3 of tape cassette 1 by the helical scan method.

Two recording heads 12A, 12B and three playback heads 13A, 13B and 13C are for example, installed in the rotating drum 11 of the tape streamer drive 10 as shown in FIG. 10.

The recording heads 12A, 12B have a structure with two gaps of mutually different azimuth angles installed in extremely close proximity.

The playback heads 13A, 13B and (13C) are heads (13A and 13C have the same azimuth) with mutually different azimuth angles, and for example are installed 90 degrees apart from each other. This is for also utilizing the playback heads 13A, 13B and 13C for readout (so-called read-after-write) immediately after recording.

Along with being rotated by the drum motor 14A, the rotating drum 11 also winds up the magnetic tape 3 that was pulled out. The magnetic tape 3 is also conveyed by the capstan motor 14B and a pinch roller not shown in the drawing. The magnetic tape 3 is also wound on the reels 2A, 2B. These reels 2A and 2B are rotated respectively in the forward direction or the reverse direction by the respective reel motors 14C and 14D.

The drum motor 14A, capstan motor 14B and reel motors 14C, 14D are respectively driven by electrical power applied from the mechanical driver 17. The mechanical driver 17 drives each motor based on control from the servo controller 16. The servo-controller 16 controls the rotation speed of each motor, to drive the tape during normal record/playback and high-speed recording, and to drive the tape during fast forward and rewind, etc.

The constants utilized in servo-control of each motor by the servo-controller 16 are stored in the EEP-ROM 18.

The servo-controller 16 connects bi-directionally, by way of the interface controller/ECC formatter 22 (hereafter called, IF/ECC controller) with the system controller 15 for overall system control.

An SCSI interface 20 is utilized in the tape streamer drive 10 for input and output of data. During recording of data for example, data is successively input from the host computer via the SCSI interface in units of transfer data called fixed length records, and supplied to a compression/expander circuit 21. In a tape streamer drive system of this type, a mode is also used for transferring data from the host computer 40 in collective units of variable length data.

The compression/expander circuit 21 if necessary, can compress the input data by means of a specified method. If for example, LZ coding is utilized as the compression method, a dedicated code assigned for character strings processed previously by this method is stored in a dictionary format. Character strings input from hereon are compared with the dictionary contents, and if the character strings of the input data match the dictionary code, then the character string data is substituted with dictionary code. Input character string data that did not match the dictionary is successively stored in dictionaries allotted with a new code. Data compression is performed in this way, by storing (registering) input character string data in the dictionary and, substituting the character string data with the dictionary code.

The output of the compression/expander circuit 21 is supplied to the IF/ECC controller 22. The IF/ECC controller 22 however, temporarily stores the output from the compression/expander circuit 21 in a buffer memory 23. Due to control implemented by the IF/ECC controller 22, the data accumulated in this buffer memory 23 is ultimately treated as fixed length data equivalent to a 40 track portion of magnetic tape called a group. The tape is then subjected to ECC formatting.

In the ECC formatting, along with adding an error correction code to the recorded data, the data is also modulated to adapt it to magnetic recording and then supplied to an RF processor 19.

The record data supplied to the RF processor 19 is amplified, subjected to record equalization, a recording signal generated and then supplied to the recording heads 12A, 12B. Data is in this way recorded on the magnetic tape 3 by the recording heads 12A, 12B.

In a brief description of data playback operation, the recording data on the magnetic tape 3 is read out as an RF playback signal from the playback heads 13A, 13B, and processing such as playback equalizing, playback clock generation, sampling and decoding (such as Viterbi decoding) are performed on that playback output by the RF processor 19.

The signal readout in this way, is supplied to the IF/ECC controller 22 and error correction first performed. After next being stored in the memory buffer 23, it is read out at a specified time point and supplied to the compression/expander circuit 21.

The compression/expander circuit 21 expands the data if determined by the system controller 15, that the data was compressed by the compression/expander circuit 21 during recording. If the data is not compressed then the data is passed through to the output without expanding the data.

The data output from the compression/expander circuit 21 is output by way of the SCSI interface 20 to the host computer 40 as playback data.

The remote memory chip 4 inside the tape cassette 1 is shown in this figure. The tape cassette 1 body is loaded in the tape streamer drive and the remote memory chip 4 is capable of inputting and outputting data to the system controller 15 in a non-contact state by way of the remote memory interface 30.

The above described communication is performed with the remote memory chip 4 by way of the remote memory interface 30 and the antenna 31. The system controller 15 can in this way access the remote memory chip 4 for reading and writing.

Data transmission with the remote memory chip 4 is performed by way of commands from the device and corresponding acknowledgments from the remote memory chips. However, when the system controller 15 issues a command to the remote memory chip 4, that command data is encoded for the remote memory interface 30 in the data structureof FIG. 7, and ASK-modulated and sent as described above.

The transmitted data is received by the antenna 5 in the tape cassette 1 as described above, and the logic section 4c operates according to the contents designed in the received data (command). The data sent along with the write command is for example written into the EEP-ROM 4d.

When a command is issued in this way from the remote memory interface 30, the remote memory chip 4 issues a corresponding acknowledgment. In other words, the logic section 4c of the remote memory chip 4 modulates the data in the RF section 4b as an acknowledgment, and transmits it from the antenna 5.

When an acknowledgment of this kind is received at the antenna 31, that received signal is demodulated in the remote memory interface 30, and supplied to the system controller 15. When a readout command for example is issued to the remote memory chip 4 from the system controller 15, the remote memory chip 4 transmits the readout data from the EEP-ROM 4d as well as a code to acknowledge that command. Whereupon, the readout data and the code acknowledgment are received and demodulated in the remote memory interface 30, and supplied to the system controller 15.

By having this remote memory interface 30, the tape streamer drive 10 can therefore access the remote memory chip 4 within the tape cassette 1.

In this kind of non-contact data exchange, the data is overlapped onto the carrier wave by ASK modulation, so that the original data is formed into packet data.

Packetizing in other words is performed, making data consisting of commands and acknowledgments into headers and parities, and adding other information required for a packet. Performing modulation after packet code conversion allows sending and receiving it as a stable RF signal.

Data used in the various processing by the system controller 15 is stored in an S-RAM 24 and a flash ROM 25.

Constants utilized for control (processes) are for example stored in the flash ROM 25.

The RAM 24 is utilized as a work memory, and as a memory for processing and storage of data such as data readout from the remote memory chip 4, write data in the remote memory chip 4, mode data in tape cassette units, and various types of flag data.

The S-RAM 24 and a flash ROM 25 may be made to comprise the internal memory of the microcomputer that constitutes the system controller 15, or may be utilized to comprise the work memory 24 constituting a portion of the area of the buffer memory 23.

Information is mutually transmitted between the tape streamer drive 10 and the host computer 40 as described above using the SCSI interface 20. The host computer 40 however, uses SCSI commands to communicate with the system controller 15.

4. Library Device Structure

The library device 50 is described next.

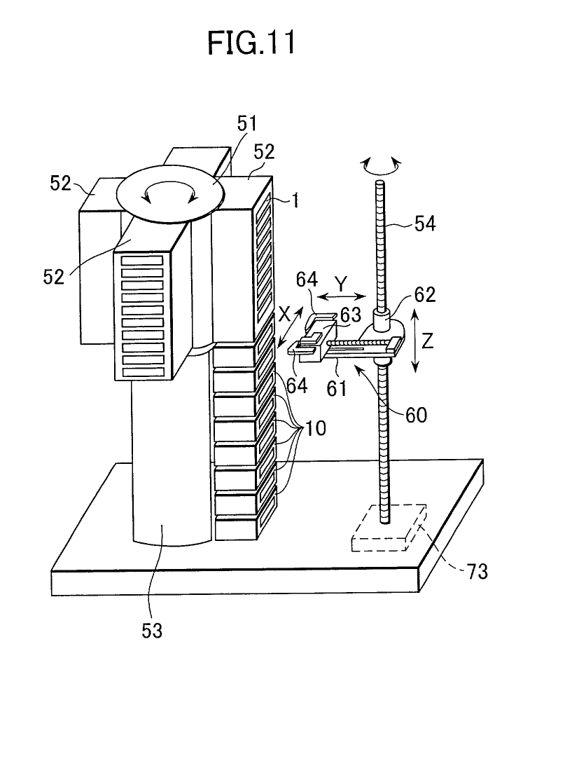

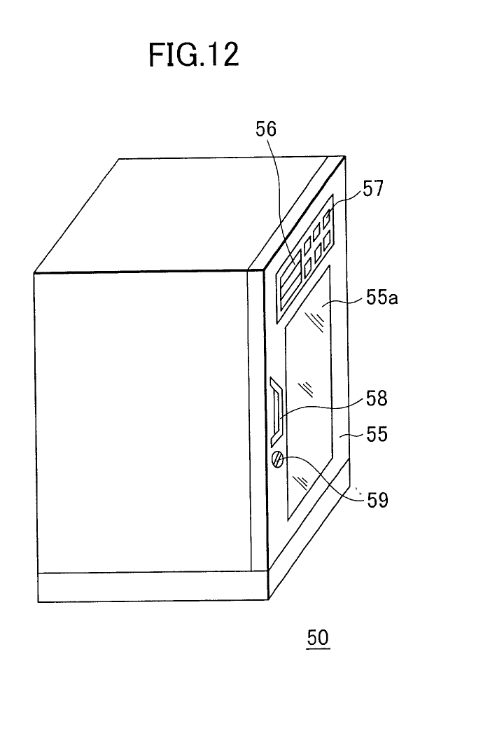

FIG. 12 is an external view of the outer box of the library device 50. FIG. 11 shows the mechanism comprising the library device 50 installed within the outer box.

The mechanism comprising the library device 50 is first described in FIG. 11.

In the library device 50 as shown in the figure, on a control box 53, four magazines 52 capable of storing about 15 tape cassettes 1, are attached for example, to a rotating carousel 51. The magazines 52 are selected by rotation of the carousel 51.

A hand unit 60 for storing and extracting the tape cassettes 1 in the magazines 52, is capable of moving up and down (Z axis direction). In other words, a gear mechanism is formed along the Z axis 54. The hand unit 60 is contrived so the axial bearing 62 engages with the gear mechanism, so that the Z axis 54 is rotated by the Z motor 73, and the hand unit 60 is moved up and down.

The hand unit 60 is installed so that the hand table 63 moves in the Y direction versus the base 61. A pair of hands 64 are installed at the ends of the hand table 63. This pair of hands 64 can grip and release the tape cassette 1 by opening and closing in the X direction.

A plurality of tape streamer drives 10 are installed beneath the carousel 51. Each tape streamer drive 10 has the structure as described above in FIG. 10.

The hand unit can extract the tape cassette 1 from the desired magazine 51 on the carousel 51 by means of this mechanism, and can convey it to the desired tape streamer drive 10. Conversely, the tape cassette 1 extracted from the tape streamer drive 10 can be stored in the desired position of the desired magazine.

The external case box for housing this mechanism has a front door 55 largely comprising the front surface, and a handle 58 for opening and closing the front door 55. The front door 55 can also be locked by a lock 59. A section on the front door 55 is installed with a transparent panel 55a, allowing a visual check of the interior to be made.

An operating panel 57 and a post 56 are formed above the front door 55. The post 56 is formed to add or extract tape cassette 1 with the front door 55 still closed. Though not shown in FIG. 11, the tape cassette 1 inserted from the post 56 can be conveyed to the desired position within the magazine 52 by the hand unit 60. The tape cassette 1 conveyed by the hand unit 60, can also be extracted from the host 56.

The keys for operation by the user are installed on the operating panel 57. Information from operating the keys on the operating panel 57 are input to the library controller 80 described later on, and operation is implemented by operation by the library controller 80. Operation by the user on this operating panel 57 include commands for inserting and extracting the tape cassette 1 from the host 56, and adjusting the library device 50, etc.

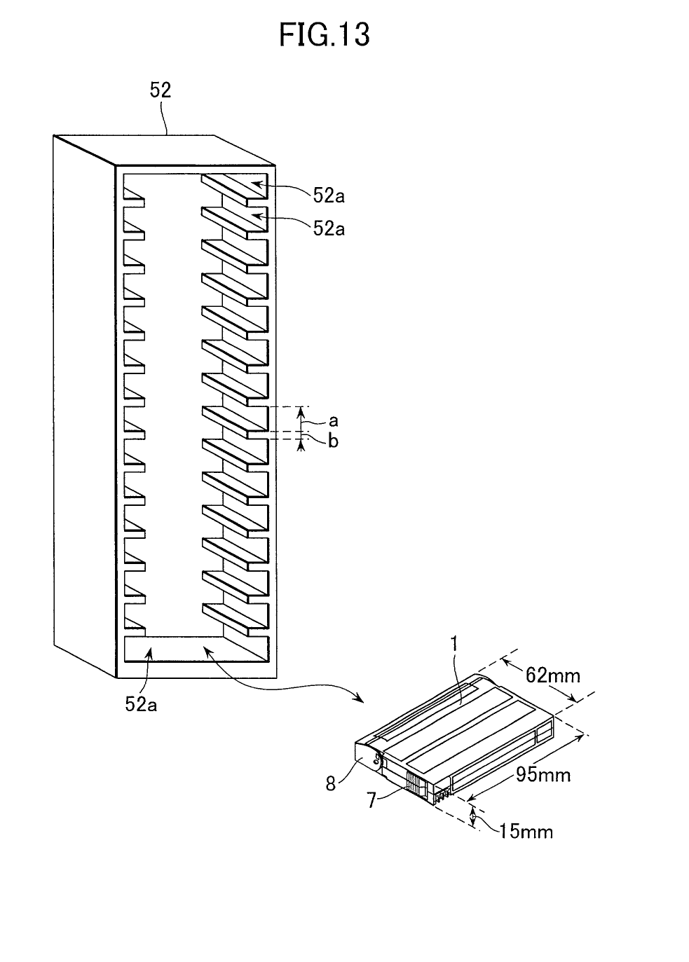

The structure of the magazine 52 is shown in FIG. 13.

Each magazine 50 is formed of approximately 15 storage sections 52a and one tape cassette 1 can be stored in each storage section 52a.

A tape cassette 1 can easily be inserted in a storage section 52a and the size of the storage section 52a can be set with sufficient gripping strength to prevent the tape cassette 1 from falling out at times such as during rotation of the carousel 51. The tape cassette 1 can also be easily extracted by the hand 64.

The height size a of each storage section 52a is for example set to a=16 millimeters since the thickness of the tape cassette 1 is approximately 15 millimeters.

The partition size b of the storage section 52a is made as thin as possible to form many storage sections 52a on the inside, and also calculated for a thickness with a certain amount of strength, so for example b=3 millimeters.

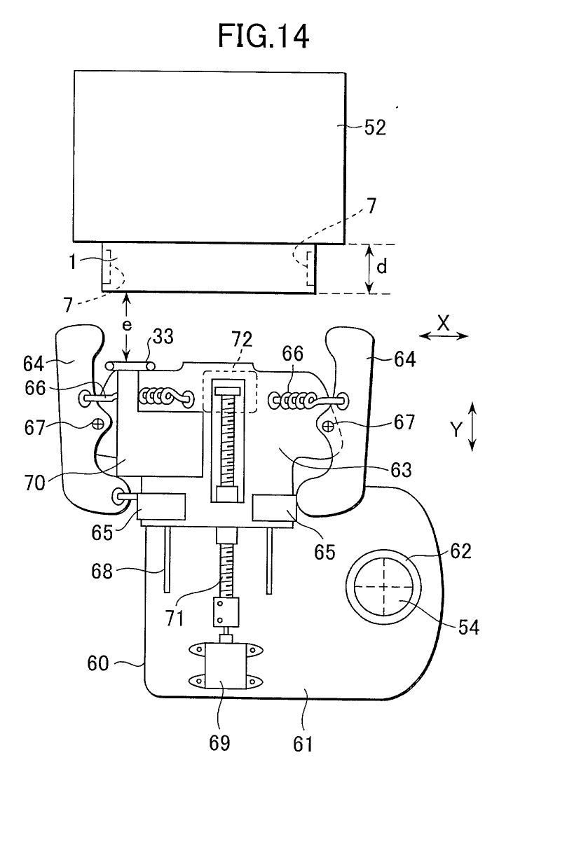

The depth is set so that the back side of the tape cassette 1 protrudes outward slightly when stored in the storage section 52a. In other words, FIG. 14 shows a tape cassette 1 inside the magazine 52 as seen from a flat view. The section d in the figure is the backside of the tape cassette 1 stored to protrude outwards. The section d at this time is approximately 20 millimeters.

In this way, the tips of the hand 64 can easily grasp the cavities 7, 7 on both sides of the tape cassette 1.

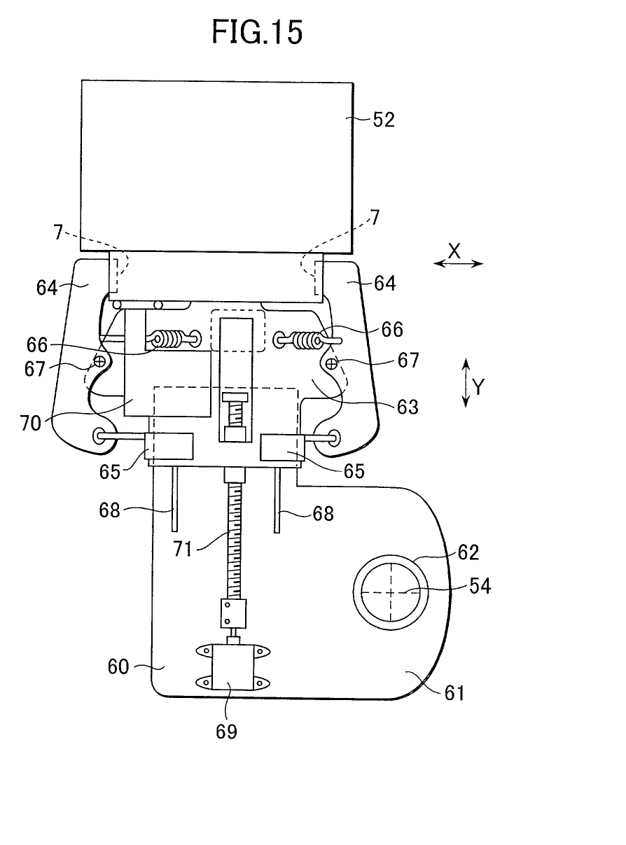

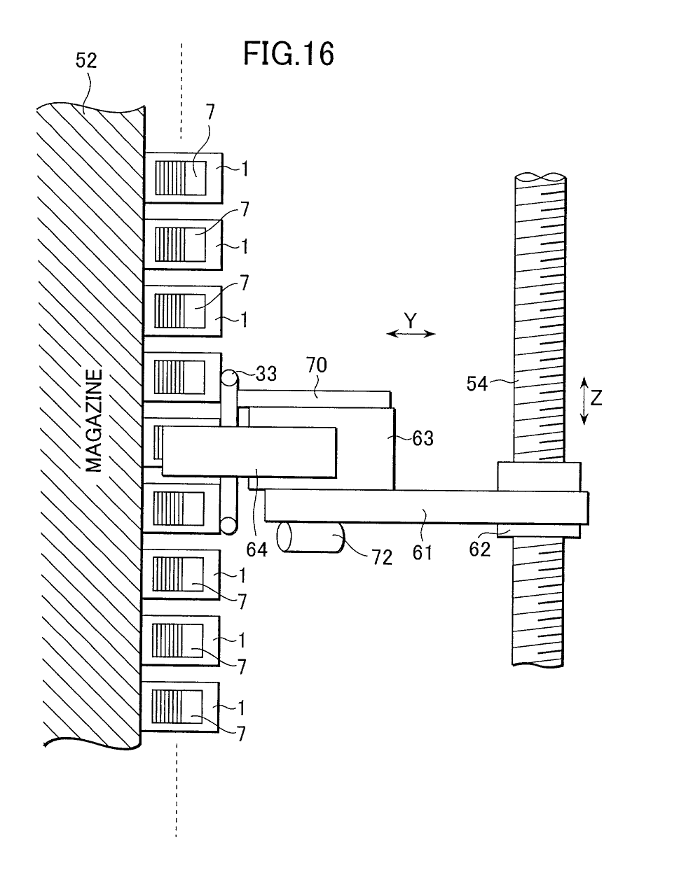

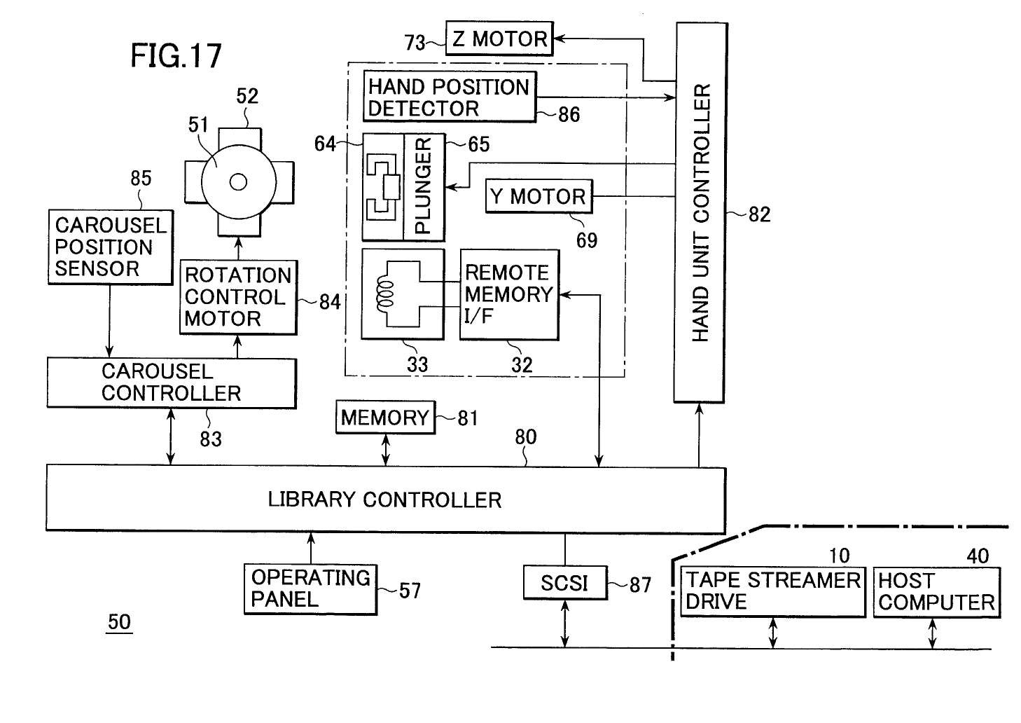

The structure and operation of the hand unit 60 is described in FIG. 14, FIG. 15 and FIG. 16.

FIG. 14 shows the hand unit 60 in a matching position separated from the tape cassette 1. FIG. 15 shows the hand unit 60 gripping the tape cassette 1. FIG. 16 shows the status in FIG. 15 as seen from the side.

The hand table 63 of hand unit 60 is installed to allow movement on the base 61. The hands 64, 64 are installed on the hand table 63.

In a status, where the axial bearing 62 installed in the base 61, is engaged with the Z axis 54, the entire hand unit 60 is gripped by the Z axis 54 so that the hand unit 60 moves up and down by the rotation of the Z axis 54, and at that point is positioned in a position facing the storage section 52a in the magazine 52, or the tape streamer drive 10.

The axial bearing 62 is formed at a position offset from the magazine 52 as seen from the direction of the front door 55 so that the Z axis 52 does not interfere when the front door 55 is opened and the tape cassette 1 is stored or extracted.

The hand table 63 is movable along a guide rail 8 in the base 61. In other words, the Y axis 71 having the gear mechanism, engages with the hand table 63, and the Y axis 71 rotated forward or backward by a Y motor 69, so that the hand table 63 moves in a direction towards or away from the magazine 52.

A pair of hands 64, 64 are installed on the hand table 63, to pivot on a support rod 67 used as a pivot point.

Each hand is set in a position pulled back by the plungers 65 on the rear edge side, as well as a position pulled by the springs 66 near the front edge from the hand table 63. Therefore, in the period where the plungers 65 are off, both hands 64 are set to a closed position by the force of the springs 66 as shown in FIG. 15. When the plungers 65 are on and the hands are pulled back to a rearward position as shown by the status of FIG. 14, so both hands 64 are in an open position opposing the force of the springs 66.

In the operation to remove a tape cassette 1 from the magazine 52, the Z axis 54 is first driven so that the hand unit 60 is moved to a position at the (same) height as the storage section 52a holding the desired tape cassette 1.

Next, both hands 64, 64 are set to an open position by the plungers 65 as shown in FIG. 14, and in that state, the hand table 63 is moved close to the magazine 52 by the Y motor 69.

When the hand table is moved to the status shown in FIG. 15, the plungers 65 are off at that point in time, and both hands 64 are therefore moved to the closed direction by the force of the springs 66. The hands 64, 64 as shown in FIG. 15, are in a position gripping the tape cassette 1 on both sides (cavity 7).

The hand unit 64 is moved still in this state, by the Y motor 69 in a direction away from the magazine 52 so that the tape cassette 1 is removed.

The extracted tape cassette 1 is conveyed by the hand unit 60 to the specified tape streamer drive 10, or post 56 or another storage section 52a of the magazine.

The reverse of the above operation is performed when the tape cassette 1 is stored inside the magazine 52.

A remote memory chip 4 however is mounted inside the tape cassette 1 as previously described, and the library device 50, the same as the tape streamer drive 10, can access the remote memory chip 4.

The remote memory drive box 70 is installed in the hand table 63 as shown in FIG. 14, FIG. 15, and FIG. 16, and the circuitry for the remote memory interface 32 is housed here. The structure of the remote memory interface 32 is described later on.

An antenna 33 is installed at a position facing the installation position of the remote memory chip 4 on the rear side of the tape cassette 1.

In the state shown in FIG. 15 for example, the antenna 33 is in considerably close proximity to the remote memory chip 4 within the tape cassette 1. In this state, access can be achieved with the remote memory chip 4 by wireless communication.

In the state in FIG. 14, the antenna 33 and remote memory chip 4 are (separated) at a distance e, however access can be achieved with an e distance of several centimeters.

FIG. 14, 15, and 16 show a barcode reader installed in the lower section of the base 61.

By installing a barcode reader 72 for example, when a tape cassette 1 affixed with a barcode label is stored, the information on that barcode label can be scanned (read). When installing the barcode reader 72, there are no particular restrictions on the installation positions of the barcode reader 72 and the antenna 33. The barcode reader 72 for example, may be installed on the hand table.

The internal structure of the library device 50 having the above mechanism is described next.

The library controller 80 is a section for controlling the entire library device 50. The library controller 80 is capable of communicating with the tape streamer 10 and the host computer 40 by way of the SCSI interface 87.

Therefore, the conveying of the tape cassette 1 between the magazine 52, the tape streamer drive 10 and the host 56, and the control of the stored tape cassette 1 (for example, accessing the remote memory chip 4 within the tape cassette 1) is implemented by SCSI commands from the host computer 40.

The memory 81 comprises the work memory utilized in processing by the library controller 80. Also, the operation information from the operating panel 56 described above, is supplied to the library controller 80, and the library controller 80 runs the required operation according to the panel operation.

A carousel controller 83 drives the rotation control motor 84 according to instructions from the library controller 80, and makes the carousel 51 rotate. In other words, runs the operation for selecting the magazine 52 with the hand unit 60. A carousel position sensor 85 detects the cursor 51 rotation position, or in other words, detects which magazine 52 (facing the hand unit 60) is selected. The carousel controller 83 makes the carousel 51 rotate while inputting information from the carousel position sensor 83 so that the desired magazine 52 is selected.

A hand unit controller 82 drives the hand unit 60 based on instructions from the library controller 80.

In other words, (hand unit controller 82) drives the Z motor 73 to move the hand unit 60 along the Z axis. The Z axis position of the hand unit 60 is detected at this time by the hand position sensor 86 so that the hand unit controller 82 drives the Z motor 73 while checking the position detection information from the hand position sensor 86. The hand unit 60 can therefore be positioned at the specified height position as instructed by the library controller 80.

The hand unit controller 82 drives the Y motor 69 and the plunger 65 at respective specified timings, and extracts and stores the tape cassette 1 with the hand 65 as described above.

Circuitry comprising the remote memory interface 32 is housed in the remote memory driver box 70 installed within the above described hand unit 60.

The structure of this remote memory interface 32 is described later on in FIG. 18 however the principle is the same as the remote memory interface inside the tape streamer drive 10 as described in FIG. 10, having the structure shown in FIG. 3.

This remote memory interface 32 is connected to the library controller 80.

This library controller 80 can by way of the remote interface 32, access and issue read and write commands to the remote memory chip 4 inside the tape cassette 1 held by the tape cassette 1 or the hand unit 60 in proximity to the antenna 33 inside the magazine 52.

In this case of course, access is also established for commands from the library controller 80 and acknowledgments from the remote memory chip 4.

Though not shown in the drawing, when installing the above described barcode reader 72, besides installing a drive circuit for the barcode reader 72, the scanned (read) information is supplied to the library controller 80.

5. Remote Memory Interface Structure and Operation

The structure and operation of the remote memory interface 32 mounted in the library device 50 are described next.

The structure of the remote memory interface 32 is shown in FIG. 18.

This remote memory interface 32 is comprised of a general-purpose computer consisting of a CPU 10, an RF section 120, and a crystal oscillator consisting of a clock generator 130.

The RF section 120 is comprised of analog circuitry, and transmits from the antenna 33, and receives data from the remote memory chip 4.

The processing for encoding the transmit data and for decoding the receive data is performed by software control in the CPU 120.

An ASK/drive amp 124 is installed in the RF section 120 as the transmit system, and during transmission supplies transmit data from the CPU 110.

Also, an envelope detector 121, an amp 122 and a comparator 123 are installed as the receive system in the RF section 120.

The RAM 11 serving as the CPU 110 shown in the figure, is a RAM incorporated in a so-called microcomputer, and for example is 4 kilobytes. In other words, a RAM commonly incorporated into a general-purpose microcomputer. A serial port 112 is also shown in the figure. The internal RAM in the example is the RAM 111 however, needless to say, a RAM may also be used as the external memory chip connected to the CPU 110.

The CPU 110 complies with instructions such as commands from the library controller 80 and achieves communication access with the remote memory chip 4. In other words, in response to the requests from the library controller 80, performs processing such as encoding (generating) transmit data for the remote memory chip 4, and decoding of receive data from the remote memory chip 4, as well as processing to send the read-out data decoded from the remote memory chip 4 receive data, and acknowledgments to the library controller 80.

The operating clock for the CPU 110 is supplied from the clock generator 130. The clock generator 130 outputs for example, a 13.56 MHz clockpulse. The operating clock frequency of the CPU 110 is therefore set at 13.56 MHz.

The carrier frequency for communications between the remote memory chip 4 and the remote memory interface is 13.56 MHz. Therefore, the 13.56 MHz clock from the clock generator 130 is utilized unchanged as the carrier frequency for the ASK/driver amp 124.

The 13.56 MHz clock from the clock generator 130 for the CPU 110, may for example be multiplied n times to obtain an operating clock frequency of 13.56×n (MHz). In any case, the operating clock frequency for the CPU 110 in this example is generated from the clock frequency from the clock generator 130. In other words, a frequency generated from a clock (fundamental) common to the carrier frequency may be used. In this example, a 13.56 MHz clock was output from the clock generator 130 however, the operating clock frequency of the CPU 110 may be x times 13.56 MHz or may be 1/x times the 13.56 MHz, and therefore dividers or multipliers may be used in any combination. The division or multiplication may also use non-integer values.

The transmit and receive operation for this kind of remote memory interface 32 is described next.

During transmit, or in other words when command packet data for transmission has been supplied to the remote memory chip 4 from the library controller 80, the CPU 110 places the preamble and synch at the front of the data packet and the CRC at the rear. In other words, performs data encoding of the data structure shown in FIG. 7.

The transmit data is also Manchester-encoded as described in FIG. 8A.

This Manchester-encoded transmit data having the data structure shown in FIG. 7 is stored in the RAM 111, and this stored transmit data WD is output from the serial port 112 to the RF section 120 at a transmit speed twice 106 Kbps.

In the RF section 120, the 13.56 MHz carrier is modulated in the ASK/drive amp 124, by ASK (amplitude shift keying) modulation with transmit data WD as explained in FIG. 5A and FIG. 5B. The modulated wave is then sent from the antenna 33 to the remote memory chip 4.

During receive, the transmit data from the remote memory chip 4 is output to the RF section 120 as information, by means of impedance variations. Envelope detection as shown in FIG. 6A, is performed with the modulation wave described in FIG. 5B by the envelope detector 121. Then, in the comparator 123, data as in FIG. 6B is binarized, to obtain the received data as shown in FIG. 6C.

This received data RD is input to the CPU 110 from the serial port 112.

In the CPU 110, the stream of input received data is subjected to 8× sampling at constant periods and accumulated in the RAM 111. These constant periods may be fixed periods, for example 9.67 milliseconds is sufficient. The amount required for accumulation in the RAM 111 is one kilobyte, and as described previously, four kilobytes of RAM in a CPU is generally sufficient.

An optimal sampling phase is determined from the receive data accumulated in the RAM 111, the preamble detected, synch detection performed, and the returned packet data is extracted from the remote memory chip 4. A CRC (cyclic redundancy check) check is also made.

The packet data from the remote memory chip 4 having undergone this decoding is sent to the library controller 80.

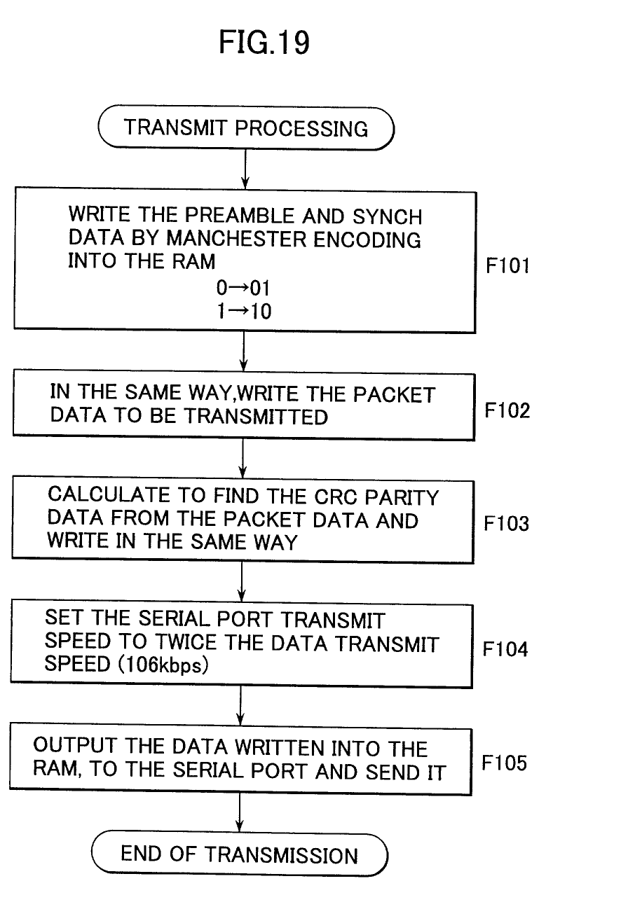

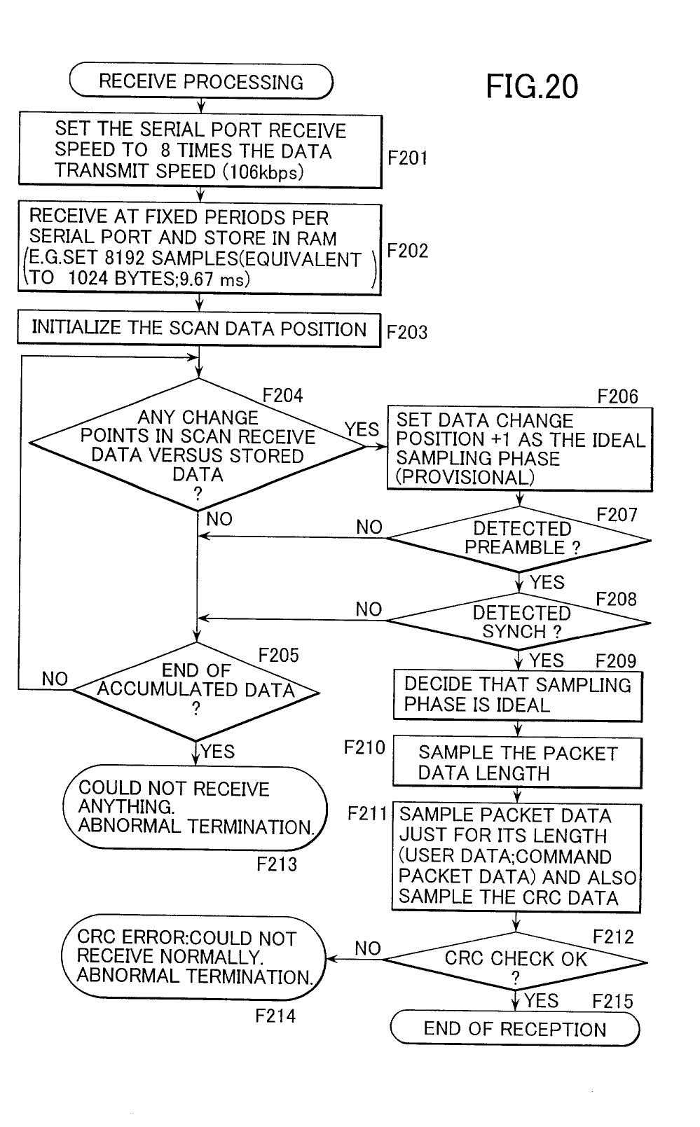

The process implemented by CPU 110 software control in the operation during the above sending and receiving is described in FIG. 19 and FIG. 20.

FIG. 19 shows the sending process.

During the sending process, the CPU 110 forms transmit data WD in the RAM 111. Therefore, in step F101, the preamble and synch comprising the transmit data are first of all written by Manchester encoding in the RAM 111.

Next, in step F102, the packet data to be transmitted, in other words, packet data such as commands sent from the library controller 80 are Manchester-encoded in the same way, and written in the RAM 111.

The packet data sent between the CPU 110 and the library controller 80 consist of a 1 byte length and 4 bytes or 20 bytes of data, as well as a 1 byte DCS (Data Check Sum). In this step F102, a 1 byte length and 4 bytes or 20 bytes of data from among packet data sent from the library controller 80, are written in the RAM 11, with the length and data in the send/receive data structure shown in FIG. 7.

When the library controller 80 requests data readout from the remote memory chip 4, the data is 4 bytes and when data writing is requested the data is 20 bytes.

In other words, during data readout, the 4 bytes of data contains a read command and read block number (address).

During data write, of the 20 bytes of data, the write command and write block number (address) are shown with 4 bytes, and the remaining 16 bytes are the actual data to be written.

In step F103, the CRC parity data of the packet (length and data) is calculated, the data Manchester-encoded in the same way, and written in the RAM 111.

In the process up to here, a packet of Manchester-encoded transmit data WD, with the data structure of FIG. 7 is formed in the RAM 111.

Next, in step F104, the transmit speed of the serial port 112 is set to twice the data transfer speed (106 Kbps).

Then, in step F105, the transmit data WD written in the RAM 111, is output to the serial port 112, supplied to the RF section 120 and transmitted.

The receive process is shown in FIG. 20.

First of all, in step F201, the receive speed of the serial port 112 is set to 8 times the data transfer speed (106 Kbps) during receive (receive period for acknowledgments of readout data after the transmit process for commands).

Then in step F202, the input from the serial port 112 is received at fixed intervals, and the receive data input from the RF section 120 is accumulated in the RAM 111.

In this case, receive data RD supplied at 106 Kbps and consisting of a Manchester-encoded data string, is sampled at 8 times oversampling (848 KHZ) and input.

In this case for example, with receive data set for 8192 sampling, the oversampling is 8 times, so is equivalent to receive data RD of 1024 bytes. The fixed period for sampling in this case is equivalent to 9.67 milliseconds.

In step F203, an initializing position is set for scanning the receive data accumulated in the RAM 111.

In step F204, the accumulated receive data is then scanned, and a search made for changes (changed points) in the data. This process continues until a change point is found, or until determined in step F205 that scanning of the accumulated data is complete.

The search scanning for change point data is a process for checking the optimal sampling phase from among 8 types of sampling phases. The above described receive data RD is Manchester-coded data, and is subjected to 8-times (8×) oversampling and accumulated in the RAM 111. A portion of a typical Manchester-coded data string is shown in FIG. 8B. Here, of the stored data values sampled by 8× oversampling for example, every one Manchester-coded data of “10” or “01” shown by an ◯ is eight point values (“1” or “0”). In other words, each (one) data sample is shown by eight ◯ so that 1024 bytes of Manchester-coded data receive data becomes 8192 samples.

Here, sampling must be performed at the correct sampling phase to obtain the original data “1” and “0” from the Manchester-coded data. This is a sampling phase correctly separated from the data change point, as shown by SPP or SPN in FIG. 8B.

In the SPP or SPN sampling of FIG. 8B, when data is sampled with an SPP sampling phase, the original “1” “0” “1” data string is extracted unchanged from the 8× sampled Manchester-coded data. However, when sampled with an SPN sampling phase, a “0” “1” “0” data string is extracted, however this is eventually restored to the original data string of “1” “0” “1” by inverting each data.

The data scanning of step F204 is a process for distinguishing optimal phase SPP or SPN.

When data scanning in sequence time-wise starting from past signals for example, a change in data for example may be found at the point shown by the arrows CP in FIG. 8B. When this kind of data change point is detected, the process proceeds to step F206, and the next sampling point (=data change position+1) is set for the optimal sampling phase. In other words, the arrows SPP in FIG. 8B are the optimal sampling phase.

In FIG. 8B, SPP was selected however SPN may sometimes be selected according to the data string. Whether or not the optimal sampling phase corresponds to SPP or to SPN is determined at the synch detection stage. This is a logic check according to the synch. When found that SPN was selected, each piece of data in data sampling from then onwards is inverted so that the data is correctly demodulated.

When the optimal sampling phase is detected, the detection of the preamble with the data structure shown in FIG. 7 is performed in step F207. The preamble data is Manchester-coded data which is “0” “1” data repeating at periodic intervals. The preamble data length, is two bytes or in other words 16 bits just as shown in FIG. 7, and after Manchester encoding, the data is inverted 32 times.

However the data will not all be a match. This happens because in actual use, the data is lost from the beginning portion of the preamble data, until the RF section 4b operation in FIG. 3 stabilizes. When scanning to attempt to match a data string whose polarity was inverted 32 times, the preamble may not be detected at all or data may be detected by mistake if data equivalent to preamble data in a user data string is present.

Therefore, when detecting the preamble, a check is made to find if the sampled data was inverted a fixed number of times less than 32 times (for example 4 times) . Using the data inversion count in this way as a basis for detecting the preamble, takes into account the fact that the beginning portion of the preamble data may be lost, and also that an optimal sampling phase has not been verified, so that a suitable number (for example 4 times) smaller than 32 times is used for reliably detecting a candidate preamble.

If the location being scanned is an actual preamble data string, then this kind of detection allows reliably detecting the preamble.

At this stage however, whether the optimum sampling phase is SPP or SPN is not determined.

Preamble detection is carried out in this way however if the preamble cannot be correctly detected, then an optimal sampling phase has not been set so the process returns in a loop of steps F204, F205.

When the preamble is detected, then the data that should be arranged behind the preamble is detected in step F208. A logic check is made simultaneously as to whether the optimum sampling phase is SPP or is SPN. If the synch was not detected here, then the optimal sampling phase that was set is not correct, so the process returns in a loop of steps F204, F205.

When detecting the synch, a synch data string having positive or negative logic is prepared beforehand, and a scanning search made to find if either of the data strings is a match. If the positive synch data string is a match, then the optimal sampling phase is determined in step F206 to correspond to SPP. If negative logic, then it corresponds to SPN. If neither (data string) is a match, then the synch could not be detected.

In the explanation for FIG. 8B, assuming that the synch data is a three bit positive logic synch data string of “1” “0” “1”, then the negative logic data string becomes “0” “1” “0”. A check is made for a match with either string, and the logic that matches, reveals whether the sampling phase is SPP or is SPN. The correct sampling phase can be determined and the logic also confirmed.

By detecting the preamble and the synch while provisionally setting the sampling phase in this way, in the process of steps F204 through F208, whether or not the sampling phase is ideal and correctly set can be determined, and the logic can be confirmed at the same time.

When determined that an ideal sampling phase was still not found and the accumulated data is terminated (scan-search of all accumulated data has ended) in step F205, then nothing could be received and the process terminates as an error in step F213.

When the preamble and synch were correctly detected for the sampling phase set in step F206, then in step F209, the sampling phase set at that point is determined to be the correct and ideal sampling phase. The logic is also confirmed at the same time. In the sample from here onwards, the data is inverted if negative logic, in order to obtain the correct data.

Then, the process proceeds to step F210, and a packet data length, that is, the value of length in data structure in FIG. 7 is sampled to determine the data length.

Then in step F211, the packet data for the determined data length portion is sampled.

Namely, the accumulated data in the above optimal sampling phase is extracted in order to extract the data and CRC shown in FIG. 7. The data contents are command codes showing read-out data and acknowledgments.

A CRC check is made of the extracted data in step F212. If the check results are not OK, then the process proceeds to step F214 and terminates abnormally as a CRC error.

When the CRC check is OK, the normal receive was achieved and the receive process ends in step F215. This receive data of course is sent to the library controller 80.

In the above embodiment, encoding and decoding were implemented on the CPU 110 by software processing, for sending and receiving per the remote memory interface 32. A dedicated (custom) IC is therefore not required for encoding and decoding. Since in particular, the CPU 110 as previously described is a general-purpose microcomputer, a compact shape and low cost can also be achieved. Further, even in cases where the communication method has been changed, the present invention can still be used by simply modifying the software.

Also in the above embodiment, the operating clock frequency of the CPU 110 matched the carrier frequency of 13.56 MHz (or a frequency corresponding to at least n times the carrier). Further, these are in complete synchronization, since the operating clock for the CPU 110 and the carrier are generated from a clock pulse from one clock generator 130.

A perfectly correct rate (106 Kbps) can therefore be obtained during transmit just by setting the frequency division rate on the serial port 112 as needed.

Synchronization during receive is generally the largest problem in a normal communications system, however in the remote memory chip 4 of this embodiment, the carrier operates (and is sent back) on a standard clock so the receive data sampling speed (8 times 106 Kbps) can also be set to obtain a perfectly correct speed for that frequency, just by setting the serial port 112 to the correct frequency division.

Synchronization of the receive data in the remote memory interface 32 is therefore almost completely unnecessary, so that synchronization control by using a PLL circuit for example is unnecessary. The provision “almost” is inserted before “completely unnecessary” because processing to detect the optimal sampling phase or in other words, only repeat synchronization is required. An overall look reveals that synchronization is greatly simplified compared to ordinary communication systems.

In the case of the above embodiment, receive data is decoded by processing in the RAM 111 and a so-called batch demodulation and therefore different from decoding systems that demodulate in succession (one after another) on dedicated (custom) ICs of the conventional art.

This batch demodulation not only increases flexibility such as for decode timing and processing procedures but also allows processing such as indexing (searching) past receive data, etc.

Encode processing is also the same in that process flexibility is expanded by utilizing the RAM 111 to form transmit data.

The example in the above embodiment described a remote memory interface 32 for the library device 50 as the communication device of the present invention, needless to say however, the remote memory interface 30 for the tape streamer drive 10 is also applicable in the same way to the present invention.

The above embodiment also described using software to process physical layers of communication (data demodulation and modulation) with the CPU 110, however the processing may also be performed on a higher layer on the same CPU. The library controller 80 for example, outputs an instruction to the CPU 110 to read out a serial number from among the contents on the remote memory chip 4. The CPU 110 receives that instruction and interprets and dismantles the address range within the applicable memory. The previously mentioned layers of physical processing are performed and data within the applicable range is read out (Readout may be performed multiple times according to the contents, and parity checks also made.), summarized into a form requested by the library controller 80 and reported.

The embodiment of the present invention was described above, however the present invention is not limited by the structures and operation shown in the figures explained up to here and the composition of the library device and tap streamer drive, the composition of the remote memory interface, the communication method with the remote memory chip, and the procedures for the transmit process/receive process can be changed as needed according to conditions of actual use. The nonvolatile memory within the remote memory chip is of course not limited to and EEP-ROM.

The embodiment of the present invention described a communication device (remote memory interface) installed in a tape streamer drive and library device for tape cassettes equipped with a nonvolatile memory for recording and playback of digital signals, however the present invention is not limited to this and may for example also be applied to record/playback systems capable of recording and playback of video signal and audio information.

What is claimed is:

1. A communications device for a non-contact type semiconductor memory, which sends and receives data to a non-contact type semiconductor memory containing a memory section installed in a recording medium for storing information relating to said recording medium, and a communications section for non-contact data transfer to said memory section, comprising:
send/receive means for sending and receiving communications without direct physical contact;
data processing means for encoding transmit data and decoding received data, wherein:
along with said data processing means performing said encoding and decoding by software processing utilizing a memory section connected to a microcomputer or formed inside said microcomputer, a clock operating frequency matches the carrier frequency of the send/receive signal of said send/receive means.

2. A communications device for a non-contact type semiconductor memory according to claim 1, comprising one clock generating means, wherein an operation clock of said data processing means and a carrier of the send/receive signal are generated based on the clock frequency from said clock generating means.

3. A communications device for a non-contact type semiconductor memory according to claim 1, wherein said data processing means accumulates the receive data obtained by said send/receive means in said memory section at specified periods, and decodes the received data accumulated in said memory section.

4. A communications device for a non-contact type semiconductor memory according to claim 1, wherein said data processing means encodes the data strings of transmit data forming said data in said memory section, and data streams of said transmit data are supplied to said send/receive means and transmitted.
